(19) United States
(12) Patent Application Publication
(10) Pub. No.: US 2025/0003784 A1
(43) Pub. Date: Jan. 2, 2025

(54) REFERENCE MEASUREMENT TECHNIQUE FOR CAPACITIVE SENSING

(71) Applicant: Microchip Technology Incorporated, Chandler, AZ (US)

(72) Inventors: Lorenzo Bellina, Belluno (IT); Maurizio Fiammeni, Monza Brianza (IT)

(21) Appl. No.: 18/759,059

(22) Filed: Jun. 28, 2024

Related U.S. Application Data
(60) Provisional application No. 63/510,980, filed on Jun. 29, 2023.

(51) Int. Cl. G01F 23/263

(52) U.S. Cl. CPC G01F 23/266

(57) ABSTRACT

Examples relate, generally, to utilizing capacitive distance measurement values to adjust capacitive liquid level measurement values.

### CROSS-REFERENCE TO RELATED APPLICATION

This application claims the benefit under 35 U.S.C. § 119(e) of U.S. Provisional Patent Application Ser. No. 63/510,980, filed Jun. 29, 2023, the disclosure of which is hereby incorporated herein in its entirety by this reference.

### FIELD

One or more examples relate, generally, to capacitive sensing. One or more examples relate, generally, to capacitive distance sensing and media level sensing.

### BACKGROUND

Capacitive sensors are used in a variety of operational contexts, for example, for capacitive proximity sensing, capacitive distance sensing, and capacitive liquid (or other media) level sensing, without limitation.

### BRIEF DESCRIPTION OF THE DRAWINGS

To easily identify the discussion of any particular element or act, the most significant digit or digits in a reference number refer to the figure number in which that element is first introduced.

FIG. 1 is a schematic diagram depicting a sensing system that includes media level measurement in accordance with one or more examples.

FIG. 2 is a schematic diagram depicting sensing system in an example environment.

FIG. 3A, FIG. 3B, and FIG. 3C are schematic diagrams that depict a sensing system according to various perspective views, in accordance with one or more examples.

FIG. 4 is a schematic diagram depicting a sensing system in an example environment.

FIG. 5 is a graph depicting a relationship between measurement values generated by a first capacitive distance sensor, a second capacitive distance sensor, and a capacitive liquid level sensor, and water level in a tank (e.g., a level of liquid volume in a tank, without limitation) in positions that correspond to the environment depicted by FIG. 5.

FIG. 6 is a schematic diagram of a sensing system in an example environment.

FIG. 7 is a graph depicting a relationship between measurement values generated by a first capacitive distance sensor, a second capacitive distance sensor, and a capacitive liquid level sensor, and water level in a tank (e.g., a level of liquid volume in a tank, without limitation) in positions that correspond to the environment depicted by FIG. 6.

FIG. 8 is a flow diagram depicting a process for adjusting capacitive liquid level measurements using capacitive distance measurements as reference values, in accordance with one or more examples.

FIG. 9 is a flow diagram depicting a process to determine a liquid level measurement, in accordance with one or more examples.

FIG. 10 is a flow diagram depicting a process to change a capacitance value at least partially based on capacitive distance measurement values, in accordance with one or more examples.

FIG. 11 is a flow diagram depicting a process to provide a capacitive liquid level sensing system in proximity of a holding structure for liquid level measurement, in accordance with one or more examples.

FIG. 12 is a flow diagram depicting a process to provide a capacitive liquid level sensing system in proximity of a holding structure for liquid level measurement, in accordance with one or more examples.

FIG. 13 and FIG. 14 are flow diagrams that together depict a process 1300 to determine a liquid level of a holding structure that changes positions, in accordance with one or more examples.

FIG. 15 is a block diagram of circuitry that, in some examples, may be used to implement various functions, operations, acts, processes, or methods disclosed herein.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment or this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer executes computing instructions (e.g., software code) related to embodiments of the present disclosure.

The embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

As used herein, any relational term, such as “over,” “under,” “on,” “underlying,” “upper,” “lower,” without limitation, is used for clarity and convenience in understanding the disclosure and accompanying drawings and does not connote or depend on any specific preference, orientation, or order, except where the context clearly indicates otherwise.

In this description, the term “coupled,” and derivatives thereof, may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The term “connected” may be used in this description interchangeably with the term “coupled,” and has the same meaning unless expressly indicated otherwise or the context would indicate otherwise to a person having ordinary skill in the art.

Self-capacitance and indications thereof may be utilized in a variety of operational context including to infer information about a material-of-interest, such as material level sensing (e.g., a level of a liquid, solution, or mixture in a tank, without limitation).

Liquid (or other media) level measurement solutions based on capacitive sensing known to the inventors of this disclosure are heavily affected by mechanical systems variations. System airgaps, variations of material composition, dielectric, thickness due to production drifts, runtime changes or application usage constrains result in capacitive based measurement errors.

One or more examples relate to a surface of an electrically floating conductive structure (a reference electrode) in-front of a surface of an electrode (a sensing electrode) of a capacitive electrode system sensor (a capacitive distance sensor). The electrically floating conductive structure provides for a stable and accurate reference measurement, by the capacitive electrode system sensor, of the material stack up between sensing electrode and liquid/media to measure.

Any application that utilizes a liquid level measurement or liquid level value may benefit from examples discussed herein. Any application that utilizes a linear liquid level measurement may benefit from examples discussed herein. Any application that utilizes a tank that is movable relative to the capacitive liquid level sensor, such as non-stationary tank such as a removable/replaceable tank, a tank that is not secured to the capacitive liquid level sensor, or a tank secured to a structure that moves relative to the capacitive liquid level sensor.

A non-limiting example of an application is as a water level sensor for a home appliance (beverage machine, steam oven, steam iron, dryer, dishwasher, without limitation).

One or more examples allow measurement of the mechanical system environment seen by the capacitive liquid level sensor without the influence of the liquid (i.e., a media to measure is need not be present).

One or more examples allow correction of a liquid level measurement at runtime, which reduces inherent related error.

One or more examples increase measurement accuracy on systems with variable materials thickness/dielectric changes due to series production drifts, temperature/humidity variations. For example, in a beverage machine accurate measurement values were obtained in the presence of mechanical variations in distance between capacitive liquid level sensor and the media volume to be measured up to 20 centimeters.

One or more examples relate to a combination of an electrical and mechanical hardware layout and a measurement technique to increase the accuracy of a capacitive liquid level sensor that measures the level of a liquid/media in a nonconductive tank.

One or more examples relate to generating measurement reference values and utilizing the reference values to reduce measurement error at the capacitive liquid level sensor introduced, as a non-limiting example, by mechanical system variation.

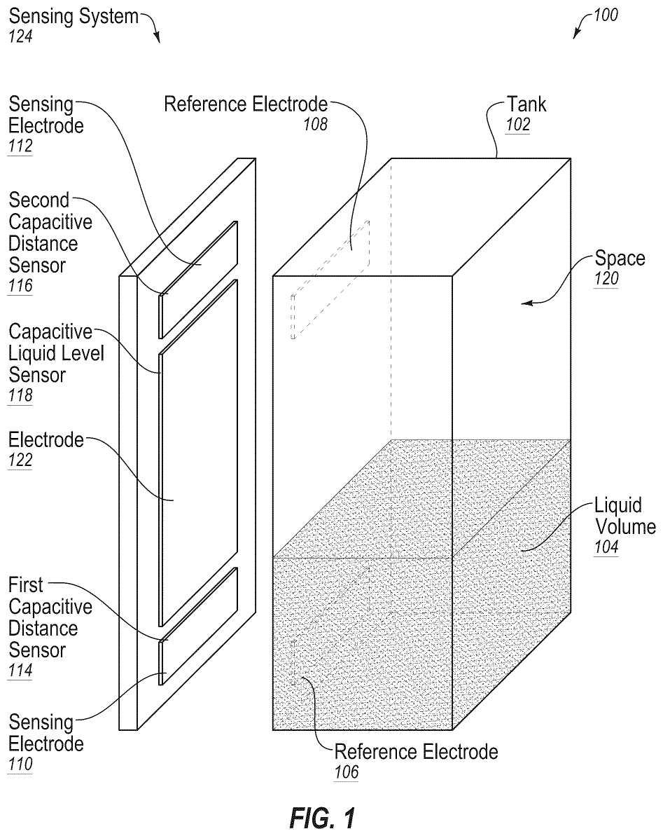

FIG. 1 is a schematic diagram depicting a liquid level sensing system 100 that includes level measurement in accordance with one or more examples.

Liquid level sensing system 100 includes a tank 102, a liquid volume 104, a reference electrode 106, a reference electrode 108, a sensing electrode 112, a sensing electrode 110, a second capacitive distance sensor 116, a first capacitive distance sensor 114, and a capacitive liquid level sensor 118.

Tank 102 is a container or vessel for holding a media to be measured. Tank 102 includes a space 120 to hold, receive, dispense, or supply, a media to be measured including liquid volume 104. Space 120 may be, as non-limiting examples, a chamber or reservoir. In one or more examples, the amount of liquid volume 104 in space 120 may change (increase or decrease). For example, tank 102 may be configured to allow liquid to ingress or egress space 120. In one or more examples, the vertical elevation of a free surface of the liquid volume 104 may change (increase/rise, decrease/fall) with respect to a bottom of tank 102. The vertical elevation of a free surface of liquid volume 104 may change because, as non-limiting examples, the amount of liquid volume 104 changes or the bottom of tank 102 changes (e.g., the bottom of tank 102 moves relative to the rest of tank 102, without limitation) the vertical elevation of the free surface of liquid volume 104. References herein to the “level” of media such as liquid volume 104 are to a vertical elevation of the free surface of the media unless explicitly stated otherwise or a person having ordinary skill in the art would understand a different meaning based on the context in which it is used.

Capacitive liquid level sensor 118 measures a level of a media in a tank and may generate values representative of the level, indicate a result of comparing the measured level to a threshold, or both, without limitation. Capacitive liquid level sensor 118 includes electrode 122 and a measurement circuit that is not visible in FIG. 1 (e.g., because it is behind electrode 122, without limitation). Capacitive liquid level sensor 118 is a self-referencing capacitive liquid level sensor. More specifically, capacitive liquid level sensor 118 is self-referencing because it includes one or more self-referencing mechanisms to compensate for changes in environmental conditions. In one or more examples, the one or more self-referencing mechanisms include a self-referencing mechanism to compensate for changes in distance between capacitive liquid level sensor 118 and tank 102, as discussed below. Capacitive liquid level sensor 118 may also include self-referencing mechanisms to compensate for changes in other environmental conditions, such as temperature, humidity, or other environmental conditions that may affect measurement accuracy, without limitation.

Electrode 122 is (e.g., is operable as, without limitation) both sensing electrode and reference electrode. When capacitive liquid level sensor 118 performs a self-capacitance measurement, it measures the capacitance between electrode 122 and its surrounding environment, and changes thereto. Here, the surrounding environment is (e.g., is or includes, without limitation) tank 102, liquid volume 104, and whatever media is in the portion of space 120 that is not holding liquid volume 104. When the level of liquid volume 104 changes the measured capacitance by capacitive liquid level sensor 118 changes (i.e., the measured capacitance before the level change and the measured capacitance after the level change, are different).

Electrode 122 is a mass of conductive material such as metal, conductive polymer, indium tin oxide, conductive layers, or coating (e.g., conductive paint, conductive adhesive, conductive film, combinations thereof, subcombinations thereof, without limitation), graphite, combinations thereof, or subcombinations thereof, without limitation. In the example depicted by FIG. 1, electrode 122 is sized and shaped to have a rectangular surface area that substantially faces tank 102. Other sizes and shapes of electrode 122 do not exceed the scope of this disclosure. In one or more examples, electrodes 122 may be sized and shaped for a specific application or operating conditions.

In one or more examples, including the specific example depicted by FIG. 1, capacitive liquid level sensor 118 and electrode 122 are located outside tank 102 (e.g., spaced apart from an outer surface of tank 102, without limitation), and do not ever come in direct physical contact with space 120 or any media therein such as liquid volume 104, without limitation.

First capacitive distance sensor 114 and second capacitive distance sensor 116 measure physical distance between respective sensing electrode 112 and sensing electrode 110 and an object, here tank 102. First capacitive distance sensor 114 includes sensing electrode 110, reference electrode 106, and a respective measurement circuit that is not visible in FIG. 1 because it is behind sensing electrode 110. Second capacitive distance sensor 116 includes sensing electrode 112, reference electrode 108 and a respective measurement circuit that is not visible in FIG. 1 because it is behind sensing electrode 112.

Reference electrode 106, reference electrode 108, sensing electrode 112, and sensing electrode 110 are respectively a mass of conductive material such as metal, conductive polymer, indium tin oxide, conductive layers, or coating (e.g., conductive paint, conductive adhesive, conductive film, combinations thereof, subcombinations thereof, without limitation), graphite, combinations thereof, subcombinations thereof, without limitation. Sensing electrode 112, sensing electrode 110, and reference electrode 106/reference electrode 108 have a known surface area, as discussed below.

Sensing electrode 112 and sensing electrode 110 respectively detect changes in capacitance. They interact with a target object or the environment being sensed. In various examples, the target object is reference electrode 106 or reference electrode 108 when in proximity thereto.

Reference electrode 106 and reference electrode 108 respectively serve as a baseline or a point of comparison for sensing electrode 112 and sensing electrode 110. In various examples, reference electrode 106 and reference electrode 108 may be considered part of sensing system 124 or part of liquid level sensing system 100 but separate from sensing system 124. In the example depicted by FIG. 1, reference electrode 106 and reference electrode 108 are electrically floating, and are not electrically coupled to a reference point (a specific location or voltage potential that is stable and may be used as a point of comparison for measuring voltages or electrical potential) or ground (e.g., do not have a direct electrical connection to a reference point or ground, without limitation). In other examples, reference electrode 106 and reference electrode 108 may be electrically coupled to a reference point or ground. The capacitance between the reference electrode 106 and reference electrode 108 and liquid volume 104 may change, but since the location of reference electrode 106/reference electrode 108 is fixed with respect to tank 102, space 120, and liquid volume 104, the capacitance remains relatively constant. Thus, reference electrode 106/reference electrode 108 help establish a stable reference point for accurate capacitance measurements.

The capacitance between sensing electrode 112/sensing electrode 110 and reference electrode 106/reference electrode 108 changes in response to factors such as distance (e.g., distance between sensing electrode and corresponding reference electrode), presence of a dielectric material, or other physical or mechanical properties. Changes in capacitance may be measured (via self-capacitance measurement process or mutual capacitance measurement process) and used to determine information about distance. In one or more examples, first capacitive distance sensor 114/second capacitive distance sensor 116 may perform a capacitance measurement and solve for distance ‘d’ between parallel plates using the parallel plate formula for capacitors, the plates being reference electrode 106, reference electrode 108, sensing electrode 112, and sensing electrode 110.

Reference electrode 106/reference electrode 108 may be disposed on the interior or exterior surface of tank 102 to be a reference for a distance measurement by second capacitive distance sensor 116/first capacitive distance sensor 114. In the specific example depicted by FIG. 1, reference electrode 106/reference electrode 108 are disposed on an exterior surface of tank 102.

In one or more examples, first capacitive distance sensor 114, second capacitive distance sensor 116, sensing electrode 110, sensing electrode 112, reference electrode 106, and reference electrode 108 may be located anywhere outside the effective region of capacitive liquid level sensor 118 (above, below, next to), and are not or negligibly in the effective region as it (e.g., their presence in the effective region, without limitation) would influence the capacitive coupling between electrode 122 and tank 102 and liquid volume 104, including in an unpredictable manner, without limitation.

In one or more examples, a measured distance is supplied to capacitive liquid level sensor 118 as an “indication of distance” (also referred to herein as a “reference value”) between electrode 122 of capacitive liquid level sensor 118 and tank 102, space 120, and a liquid volume 104 therewithin. In one or more examples, Reference values may be respectively supplied by first capacitive distance sensor 114 and second capacitive distance sensor 116, without limitation. Capacitive liquid level sensor 118 may, as discussed below, utilize the reference values to change (or more generally, to determine) capacitive measurements to increase precision, which increases precision of liquid level measurements at least partially based thereon. In one or more examples, a first reference value generated by first capacitive distance sensor 114 and a second reference value generated by second capacitive distance sensor 116 are used to change a sensor value generated by capacitive liquid level sensor 118. In various examples, the sensor value may be a capacitance value that will be used to calculate a liquid level or a liquid level value.

Additionally or alternatively, capacitive liquid level sensor 118 may utilize reference values to change (or more generally, to determine) values based on its capacitive measurements to increase precision such as values that represent a liquid level, without limitation.

While two capacitive distance sensors are shown and used in various examples discussed here, more than two capacitive distance sensors may be used without exceeding the scope of this disclosure, and is specifically contemplated.

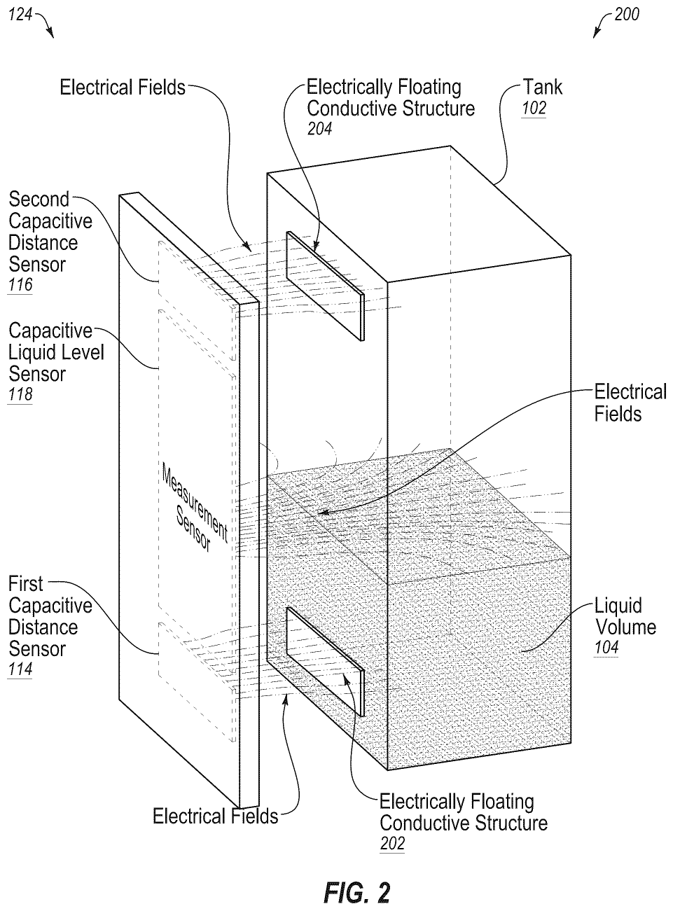

FIG. 2 is a schematic diagram depicting liquid level sensing system 100 in an example environment 200.

Electrical fields provided by first capacitive distance sensor 114 and second capacitive distance sensor 116 via sensing electrode 110 and sensing electrode 112, respectively, are closing their lines on the conductive surfaces of electrically floating conductive structure 204 of reference electrode 108 and of electrically floating conductive structure 202 of reference electrode 106, respectively. It will be understood, of course, that the lines of the electric fields depicted by FIG. 2 are visual representations of direction and strength of the electric fields in regions of space and are provided as an intuitive way to understand behavior of the electric fields discussed herein.

The respective material of electrically floating conductive structure 204 and electrically floating conductive structure 202 may be the same or different. In one or more examples, electrically floating conductive structure 204 and electrically floating conductive structure 202 may be formed on an electrode copper area on a surface of tank 102. The materials of respective electrically conductive structures of sensing electrode 110 and sensing electrode 112 may be the same or different. In one or more examples, the electrically conductive structures of sensing electrode 110 and sensing electrode 112 may be formed of an electrode copper area on a printed-circuit-board (PCB) coupled to a microcontroller that implements one or more of first capacitive distance sensor 114, second capacitive distance sensor 116, and capacitive liquid level sensor 118.

Reference measurements (via first capacitive distance sensor 114 and second capacitive distance sensor 116) are only affected by the airgap or other materials between the reference electrodes and the reference floating surfaces (e.g., surfaces of electrically floating conductive structure 204 and electrically floating conductive structure 202 facing sensing system 124, without limitation) but not by the liquid or air inside the container.

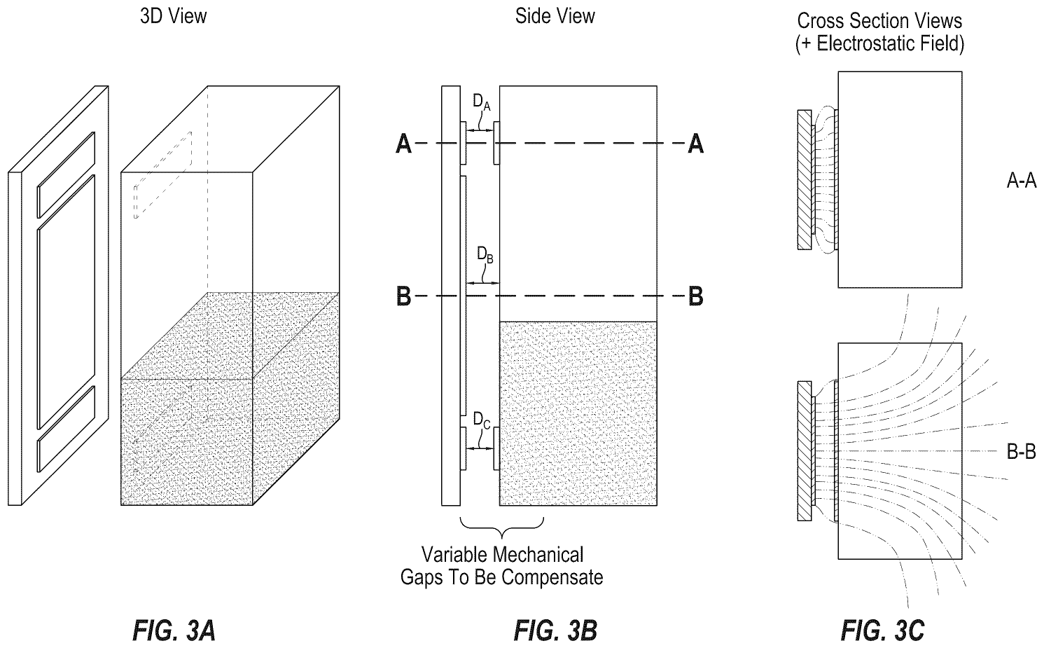

FIG. 3A, FIG. 3B, and FIG. 3C are schematic diagrams depicting a liquid level sensing system 100 according to various perspective views.

FIG. 3A is an isometric view of liquid level sensing system 100.

The side view of FIG. 3B depicts mechanical gaps (here, air gaps) between sensing system 124, including first capacitive distance sensor 114, second capacitive distance sensor 116, capacitive liquid level sensor 118, and a side wall of tank 102. Although generally appearing generally uniform in FIG. 3B, the mechanical gaps may have variable dimensions. Stated another way, the distance from points of sensing system 124 to points of the side wall of tank 102 at a same vertical elevation may differ. For example, a distance between sensing electrode 112 and reference electrode 108 on vertical plane A may be different (e.g., notwithstanding any thickness of reference electrode 108 protruding from the exterior surface of tank 102, if any, without limitation) than a difference between electrode 122 and a side wall of tank 102. Indeed, the horizontal width of a geometric space defining the mechanical gap between sensing system 124 and tank 102 at a specific moment in time may change based on the vertical elevation at which it is taken.

Further, the width of a mechanical gap (distances between the sensing system and the side wall of tank 102) may change over time, including closing a mechanical gap or forming a mechanical gap.

FIG. 3C is a top down view of cross-sections of liquid level sensing system 100 taken at vertical levels A and B in FIG. 3B. The cross-sections of FIG. 3C show example electrical fields from first capacitive distance sensor 114 or second capacitive distance sensor 116 reaching a reference electrode (e.g., reference electrode 106 or reference electrode 108, without limitation) and then substantially ending at the reference electrode, while the electric fields from capacitive liquid level sensor 118 reach into tank 102 and interact with the tank 102, the liquid volume 104, and whatever media is in space 120 (e.g., air).

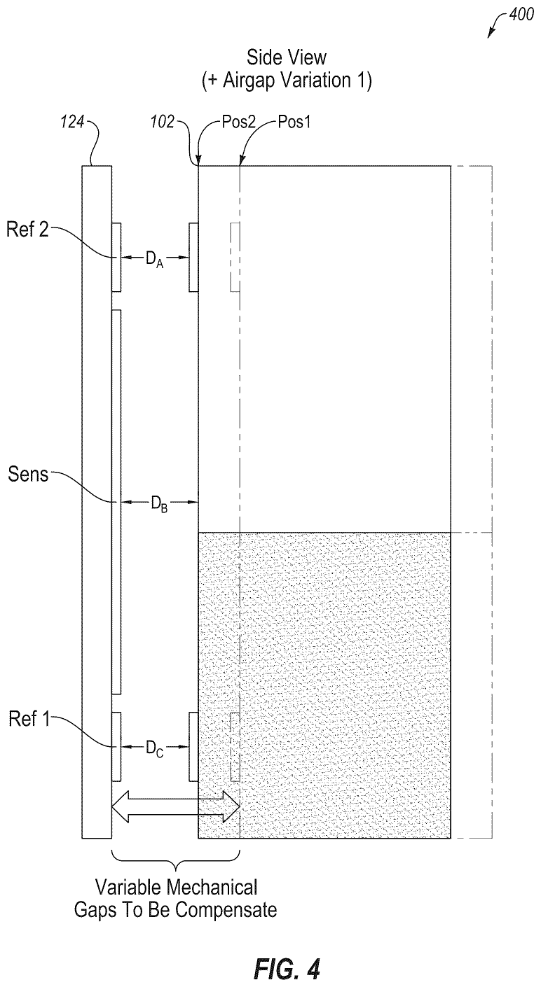

FIG. 4 is a schematic diagram depicting a liquid level sensing system 100 in an example environment 400. In the example depicted by FIG. 4, a magnitude of a distance between the sensing system (and more specifically, electrode 122, sensing electrode 110, and sensing electrode 112) and a side-wall of tank 102 changes from first position “Pos1” to a second position “Pos 2.” In this specific example, the position of tank 102 (and liquid volume 104, and space 120) changes with respect to the sensing system, which is stationary. This disclosure is not limited to changes in the position of the tank 102, and changes in the position of the sensing system 124 with respect to tank 102 and changes in respective positions of both the sensing system and tank 102 are specifically contemplated and do not exceed the scope.

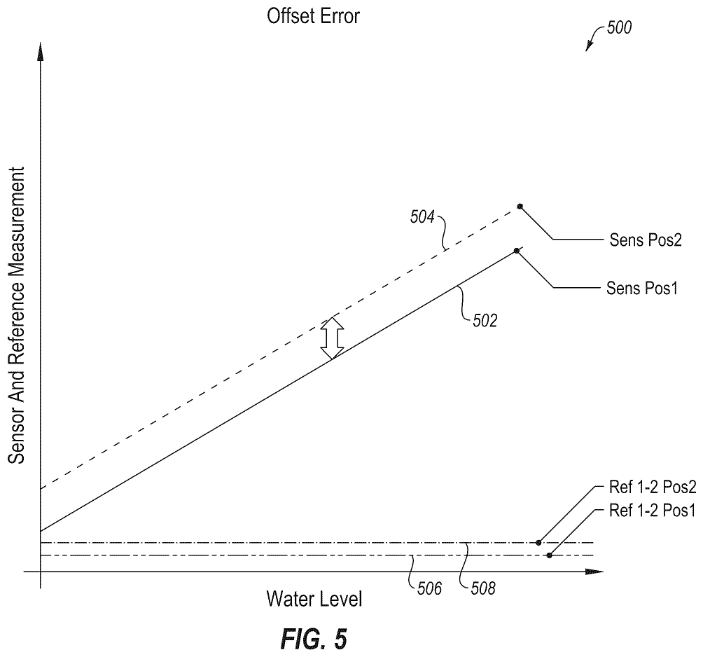

FIG. 5 is a graph 500 depicting a relationship between measurement values generated by first capacitive distance sensor 114, second capacitive distance sensor 116, and capacitive liquid level sensor 118, and water level in a tank (e.g., a level of liquid volume 104 in tank 102, without limitation). This disclosure is not limited to water and even liquid forms of media, use of various examples with other media and forms of media does not exceed the disclosure of this disclosure.

The Y-axis represents capacitive measurements and reference values generated by capacitive liquid level sensor 118, first capacitive distance sensor 114, and second capacitive distance sensor 116, as the case may be. Values for water level associated with the x-axis increase from left to right and so represent increasing water levels from left to right. Values for measurements associated with the y-axis increase from bottom to top and so represent increasing measurement values from bottom to top. In this example, measurement values change (e.g., increase or decrease, without limitation) directly proportionally with change (e.g., increase or decrease, without limitation) in water level. The positions Pos1 and Pos2 referenced in the graph substantially correspond to the positions depicted in FIG. 4.

Line 502 represents a relationship between measurements generated by capacitive liquid level sensor 118 and water level at first position Pos1. Line 504 represents a relationship between measurements generated by capacitive liquid level sensor 118 and water level at second position Pos2. A double-sided arrow is used to indicate that there is a non-zero perpendicular distance between line 502 and line 504.

Line 506 and line 508 represent differences between reference value Ref1 (generated by one of first capacitive distance sensor 114 or second capacitive distance sensor 116) and reference value Ref2 (generated by the other one of first capacitive distance sensor 114 or second capacitive distance sensor 116) taken at first position Pos1 and at second position Pos2, respectively, between the sensing system and tank 102.

Notably, the change in difference between first reference value Ref1 and second reference value Ref2 may be used to determine a change in a capacitive measurement used for liquid level sensing. As a non-limiting example, the change in difference between first reference value Ref1 and second reference value Ref2 taken at different times, e.g., at time 0 and time 1, without limitation, may be detected and a capacitive measurement by the capacitive liquid level sensor 118 at time 1 may be changed so that it can be used to detect a change in liquid level compared to a capacitive measurement by capacitive liquid level sensor 118 at time 0.

Since first reference value Ref1 and second reference value Ref2 remain constant, they may be used to change a capacitive measurement by capacitive liquid level sensor 118 as discussed below.

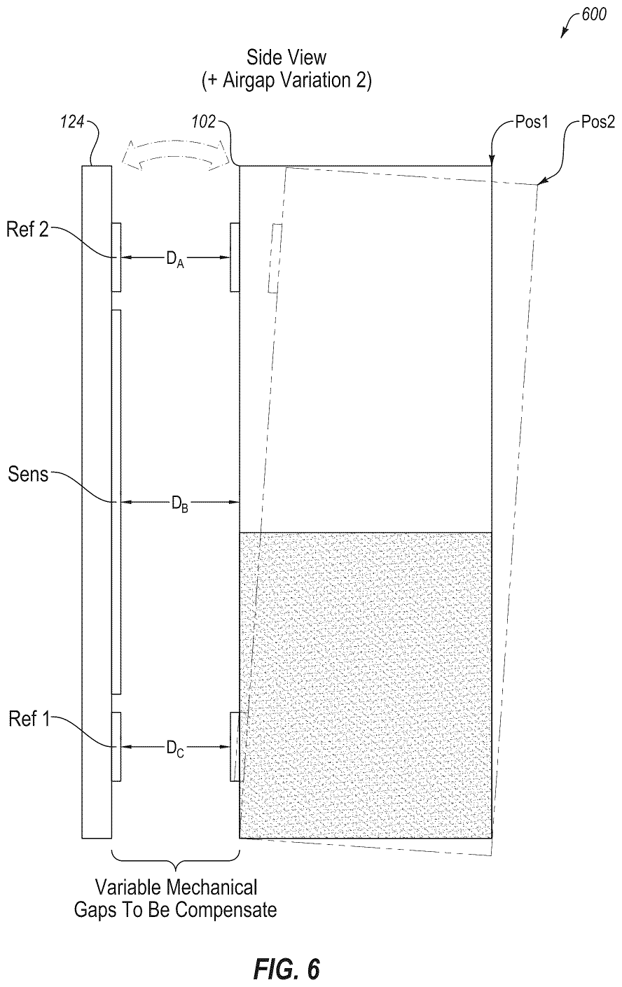

FIG. 6 is a schematic diagram of a liquid level sensing system 100 in an example environment 600.

Here, the mechanical gap between a point at the top of sensing system and a top of a side wall of tank 102 than the mechanical gap between a point at the bottom of the sensing system and a bottom of the side wall of tank 102. The mechanical gap between points of the sensing system and points at the side wall of the tank 102 increases from bottom to top. In this example, it is because tank 102 tilts from position 1 to position 2 where it is tilted.

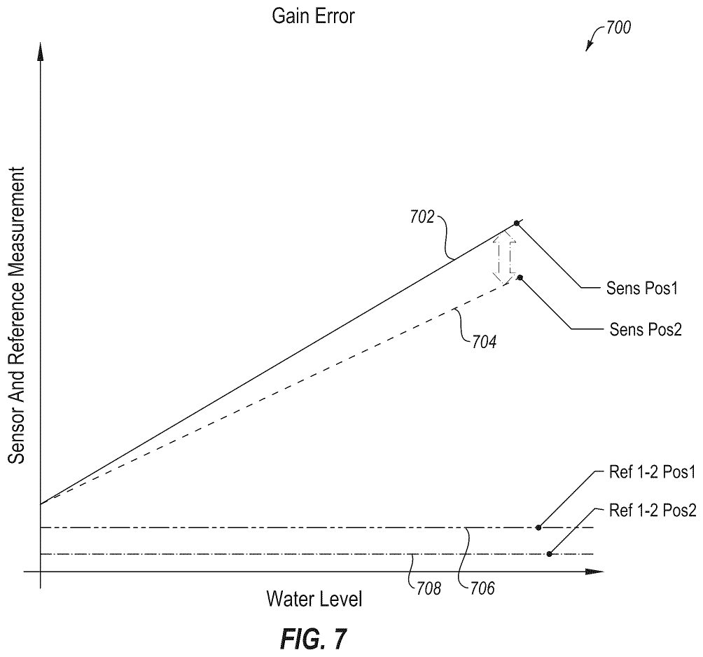

FIG. 7 is a graph 700 depicting a relationship between measurement values generated by first capacitive distance sensor 114, second capacitive distance sensor 116 and capacitive liquid level sensor 118, and water level in a tank (e.g., a level of liquid volume 104 in tank 102, without limitation).

Line 706 and line 708 represent relationships between measurements generated by capacitive liquid level sensor 118 and water level at first position Pos1 and a second position Pos2, respectively. First position Pos1 and second position Pos2 correspond to first position Pos1 and second position Pos2 of tank 102 depicted by FIG. 6. Notably, line 702 and line 704 are not perpendicular. So, the linear relationship between capacitive measurement and liquid level represented by line 706 is different than the linear relationship between capacitive measurement and liquid level presented by line 708. The difference in the linear relationship is represented by different respective rates of change of line 702 and line 704, and visually represented by a widening distance between line 702 and line 704 that generally corresponds to the widening mechanical gap from bottom to top when in first position Pos1 and second position Pos2.

Line 702 and line 704 represent differences between reference value Ref1 (generated by one of first capacitive distance sensor 114 or second capacitive distance sensor 116) and reference value Ref2 (generated by the other one of first capacitive distance sensor 114 or second capacitive distance sensor 116) taken at first position Pos1 and at second position Pos2, respectively. Notably, since the location of reference electrode 106 and reference electrode 108 is fixed with respect to tank 102, space 120, and liquid volume 104, the first reference value Ref1 and second reference value Ref2 are both generally constant with changing liquid levels.

Since first reference value Ref1 and second reference value Ref2 remain constant, they may be used to change a capacitive measurement by capacitive liquid level sensor 118 as discussed below.

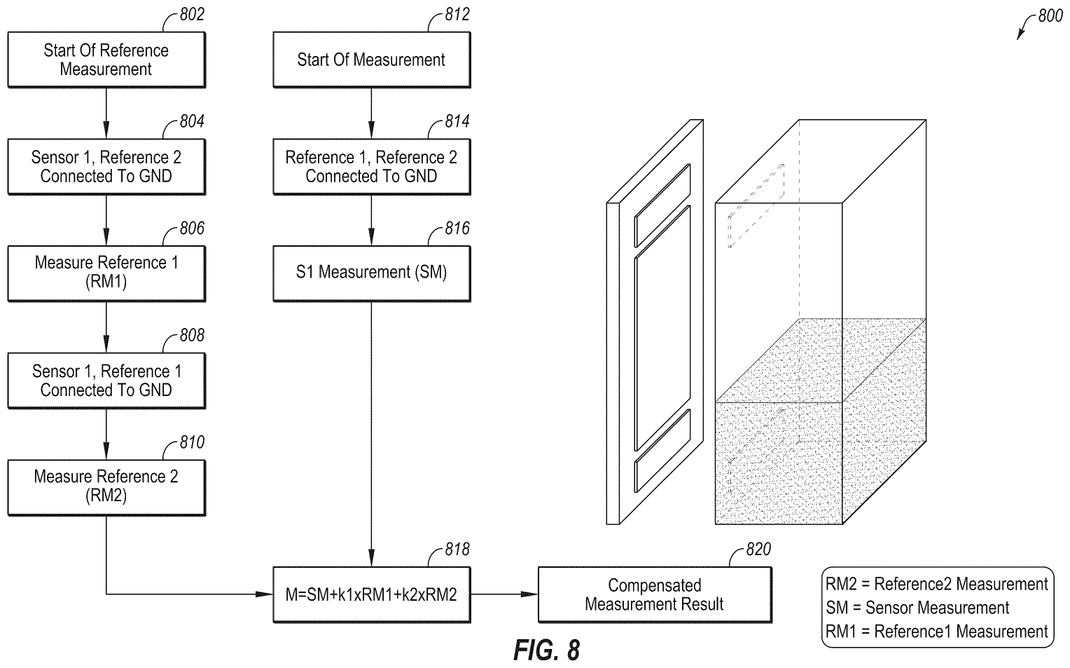

FIG. 8 is a flow diagram depicting a process 800 for adjusting capacitive liquid level measurements using capacitive distance measurements as reference values, in accordance with one or more examples. In one or more examples, one or more of the operations discussed with respect to process 800 may be performed by liquid level sensing system 100.

Operation 802 includes start of reference measurement.

Operation 804 includes sensor 1 and reference 2 connected to ground (GND). Capacitive liquid level sensor 118, second capacitive distance sensor 116, sensing electrode 112, and electrode 122 are coupled to ground voltage source. First capacitive distance sensor 114 and sensing electrode 110 are not coupled to ground voltage source at this time.

Operation 806 includes measure reference 1 (RM1). First capacitive distance sensor 114 performs a capacitive distance measurement, and generates a value “RM1” in response to the measurement.

Operation 808 includes sensor 1 and reference 1 connected to ground (GND). Capacitive liquid level sensor 118, first capacitive distance sensor 114, sensing electrode 110, and electrode 122 are coupled to a ground voltage source. Second capacitive distance sensor 116 and sensing electrode 112 are not coupled to ground voltage source at this time.

Operation 810 includes measure reference 2 (RM2). Second capacitive distance sensor 116 performs a capacitive distance measurement, and generates a value “RM2” in response to the measurement.

Operation 812 includes start of measurement. This is the start of a measurement by capacitive liquid level sensor 118.

Operation 814 includes reference 1 and reference 2 connected to ground (GND). First capacitive distance sensor 114, sensing electrode 110, second capacitive distance sensor 116, and sensing electrode 112 are coupled to a ground voltage source. capacitive liquid level sensor 118 and electrode 122 are not coupled to a ground voltage source at this time.

Operation 816 includes s1 measurement (SM). Capacitive liquid level sensor 118 performs a capacitive liquid level sensing measurement and generates a value “SM” in response to the measurement.

Operation 818 includes M=SM+k1(RM1)+k2(RM2). The values RM1 and RM2 are multiplied by scaling factors k1 and k2 and combined to obtain an adjustment amount. The adjustment amount is added to the value SM to obtain an adjusted capacitive liquid level measurement value. In some instance the adjustment may be positive and in others it may be negative depending on whether capacitance value was increased or decreased by the change in position. In one or more examples, scaling factors k1 and k2 may be linear functions, non-linear functions, or expressions defined by piecewise functions. In one or more examples, scaling factors k1 and k2 may be chosen to scale the first reference value and the second reference value according to a predetermined linear or non-linear relationships. Alternatively or additionally, in one or more examples scaling factors k1 and k2 may be chosen based a non-linear relationship between the error in a capacitance value captured and used for liquid measurement and the width of an air gap, for example, based on the formula for a planar capacitor C=ϵ*S/d, where ‘d’ is the distance between capacitor plates in the formula and here corresponds to the width of the mechanical gap, ‘S’ is the area of the plates of the capacitor and here corresponds to the area of the sensor electrodes and reference electrodes, and epsilon ‘ϵ’ is the permittivity/dielectric constant of the material between the capacitor plates and here may correspond to the permittivity of the air between the sensor electrodes and reference electrodes.

Operation 820 includes compensated measurement result. The adjusted value is output or stored as a value representative of the water level in tank 102.

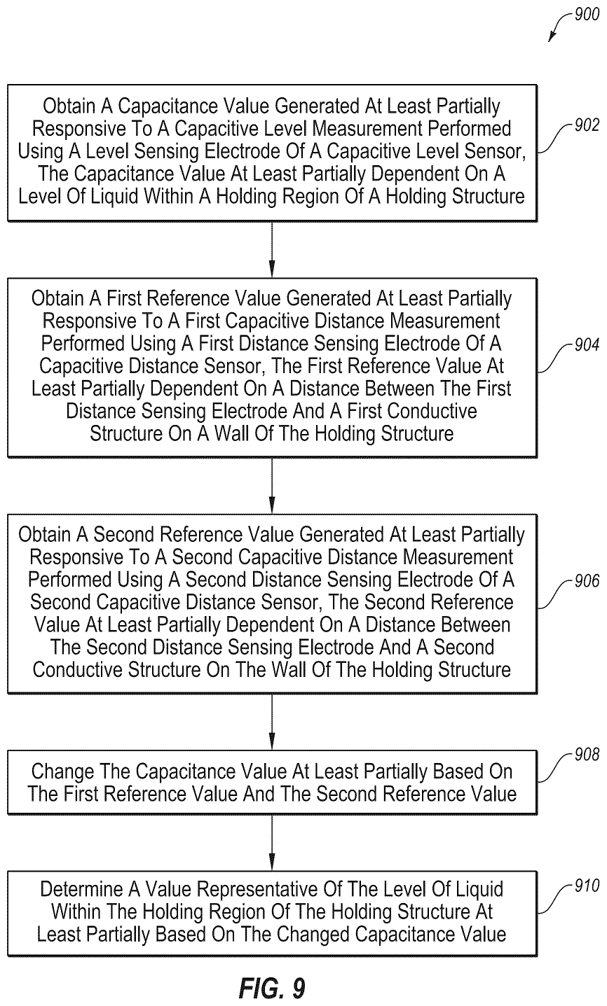

FIG. 9 is a flow diagram depicting a process 900 to determine a liquid level measurement, in accordance with one or more examples. Although the example process 900 depicts a particular sequence of operations, the sequence may be altered without departing from the scope of the present disclosure. For example, some of the operations depicted may be performed in parallel or in a different sequence that does not materially affect the function of the process 900. In other examples, different components of an example device or system that implements the process 900 may perform functions at substantially the same time or in a specific sequence. One or more operations of process 900 may be performed, as a non-limiting example, by liquid level sensing system 100 and sensing system 124.

According to one or more examples, process 900 may include obtaining a capacitance value generated at least partially responsive to a capacitive level measurement performed using a level sensing electrode of a capacitive level sensor, the capacitance value at least partially dependent on a level of liquid within a holding region of a holding structure at operation 902.

According to one or more examples, process 900 may include obtaining a first reference value generated at least partially responsive to a first capacitive distance measurement performed using a first distance sensing electrode of a capacitive distance sensor, the first reference value at least partially dependent on a distance between the first distance sensing electrode and a first conductive structure on a wall of the holding structure at operation 904.

According to one or more examples, process 900 may include obtaining a second reference value generated at least partially responsive to a second capacitive distance measurement performed using a second distance sensing electrode of a second capacitive distance sensor, the second reference value at least partially dependent on a distance between the second distance sensing electrode and a second conductive structure on the wall of the holding structure at operation 906.

According to one or more examples, process 900 may include changing the capacitance value at least partially based on the first reference value and the second reference value at operation 908.

According to one or more examples, process 900 may include determining a value representative of the level of liquid within the holding region of the holding structure at least partially based on the changed capacitance value at operation 910.

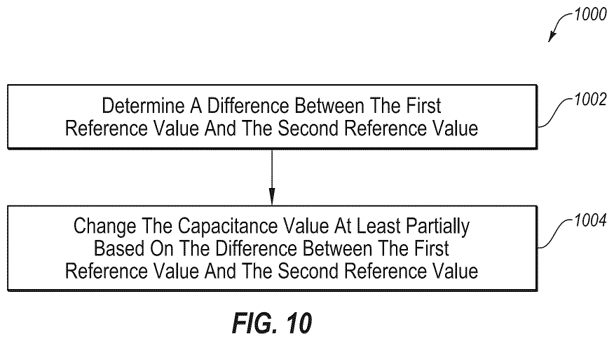

FIG. 10 is a flow diagram depicting a process 1000 to change a capacitance value at least partially based on capacitive distance measurement values, in accordance with one or more examples. Although the example process 1000 depicts a particular sequence of operations, the sequence may be altered without departing from the scope of the present disclosure. For example, some of the operations depicted may be performed in parallel or in a different sequence that does not materially affect the function of the process 1000. In other examples, different components of an example device or system that implements the process 1000 may perform functions at substantially the same time or in a specific sequence. One or more operations of process 1000 may be performed, as a non-limiting example, by liquid level sensing system 100 and sensing system 124.

According to one or more examples, process 1000 may include determining a difference between the first reference value and the second reference value at operation 1002.

According to one or more examples, process 1000 may include changing the capacitance value at least partially based on the difference between the first reference value and the second reference value at operation 1004.

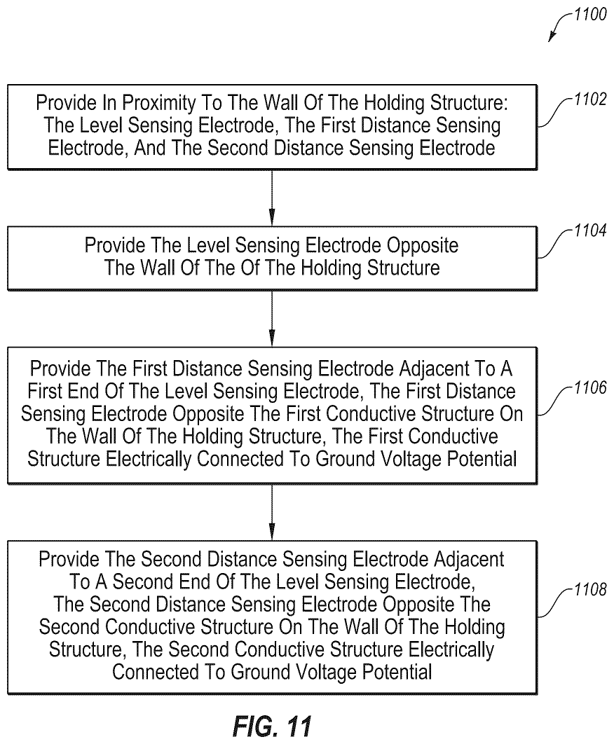

FIG. 11 is a flow diagram depicting a process 1100 to provide a capacitive liquid level sensing system in proximity of a holding structure for liquid level measurement, in accordance with one or more examples. Although the example process 1100 depicts a particular sequence of operations, the sequence may be altered without departing from the scope of the present disclosure. For example, some of the operations depicted may be performed in parallel or in a different sequence that does not materially affect the function of the process 1100. In other examples, different components of an example device or system that implements the process 1100 may perform functions at substantially the same time or in a specific sequence. One or more operations of process 1100 may be performed, as a non-limiting example, by liquid level sensing system 100 and sensing system 124.

According to one or more examples, process 1100 may include providing, in proximity to the wall of the holding structure: the level sensing electrode, the first distance sensing electrode, and the second distance sensing electrode at operation 1102.

According to one or more examples, process 1100 may include providing the level sensing electrode opposite the wall of the holding structure at operation 1104.

According to one or more examples, process 1100 may include providing the first distance sensing electrode adjacent to a first end of the level sensing electrode, the first distance sensing electrode opposite the first conductive structure on the wall of the holding structure, the first conductive structure electrically connected to ground voltage potential at operation 1106.

According to one or more examples, process 1100 may include providing the second distance sensing electrode adjacent to a second end of the level sensing electrode, the second distance sensing electrode opposite the second conductive structure on the wall of the holding structure, the second conductive structure electrically connected to ground voltage potential at operation 1108.

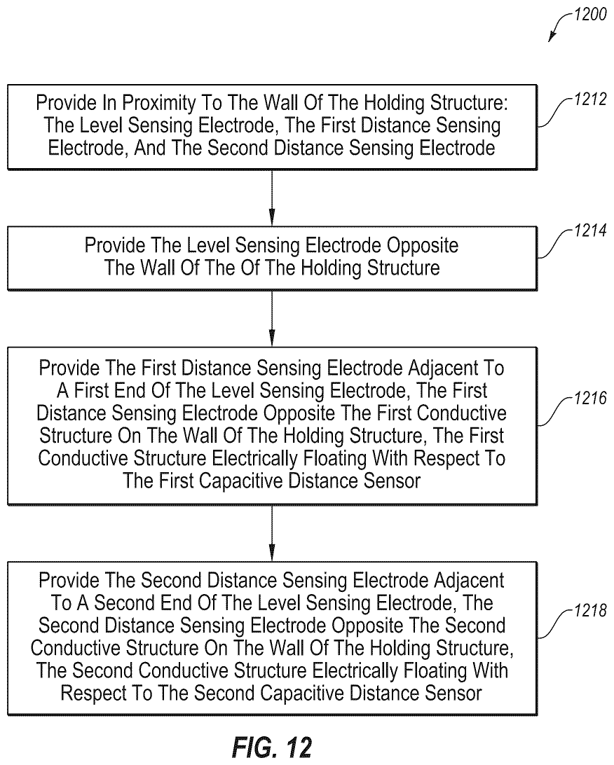

FIG. 12 is a flow diagram depicting a process 1200 to provide a capacitive liquid level sensing system in proximity of a holding structure for liquid level measurement, in accordance with one or more examples. Although the example process 1200 depicts a particular sequence of operations, the sequence may be altered without departing from the scope of the present disclosure. For example, some of the operations depicted may be performed in parallel or in a different sequence that does not materially affect the function of the process 1200. In other examples, different components of an example device or system that implements the process 1200 may perform functions at substantially the same time or in a specific sequence. One or more operations of process 1200 may be performed, as a non-limiting example, by liquid level sensing system 100 and sensing system 124.

According to one or more examples, process 1200 may include providing in proximity to the wall of the holding structure: the level sensing electrode, the first distance sensing electrode, and the second distance sensing electrode at operation 1212.

According to one or more examples, process 1200 may include providing the level sensing electrode opposite the wall of the holding structure at operation 1214.

According to one or more examples, process 1200 may include providing the first distance sensing electrode adjacent to a first end of the level sensing electrode, the first distance sensing electrode opposite the first conductive structure on the wall of the holding structure, the first conductive structure electrically floating with respect to the first capacitive distance sensor at operation 1216.

According to one or more examples, process 1200 may include providing the second distance sensing electrode adjacent to a second end of the level sensing electrode, the second distance sensing electrode opposite the second conductive structure on the wall of the holding structure, the second conductive structure electrically floating with respect to the second capacitive distance sensor at operation 1218.

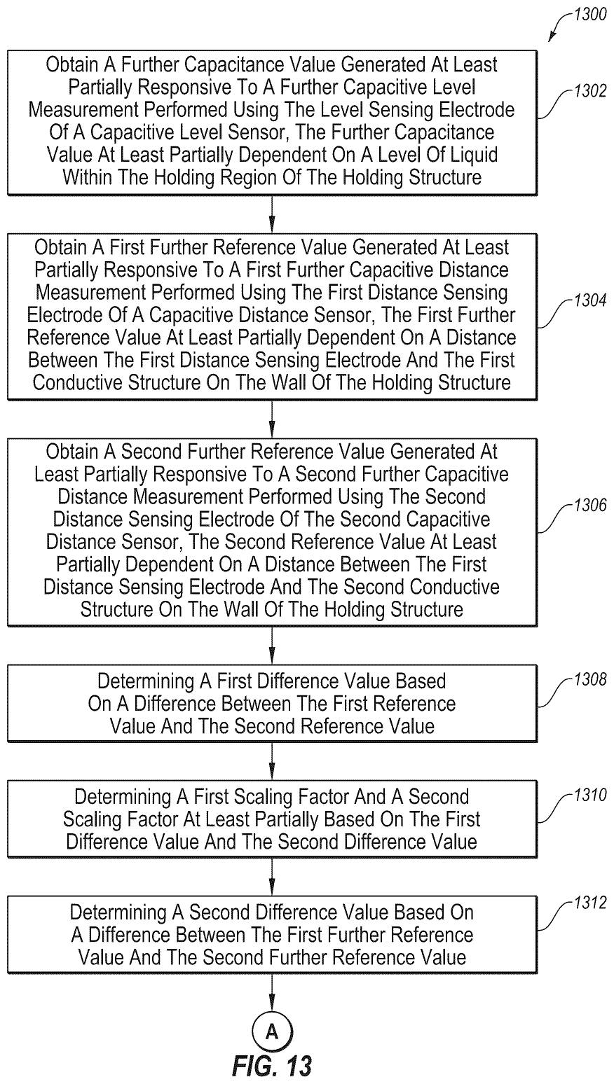

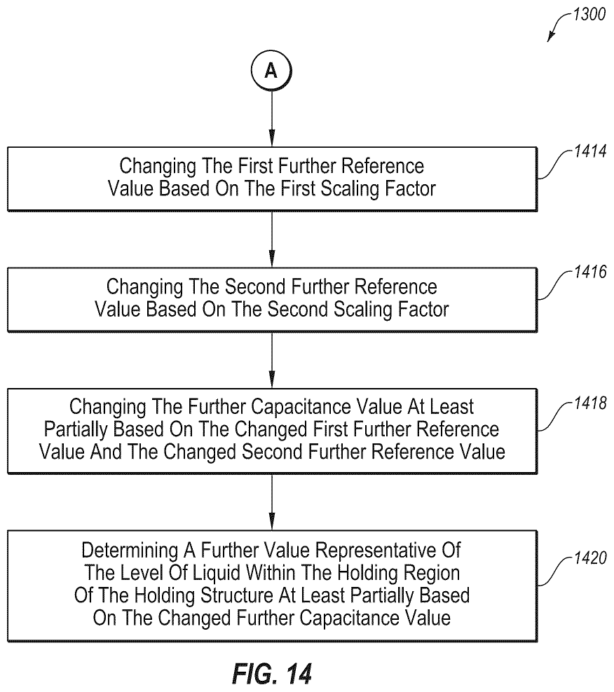

FIG. 13 and FIG. 14 are flow diagrams that together depict a process 1300 to determine a liquid level of a holding structure that changes positions, in accordance with one or more examples.

Although the example process 1300 depicts a particular sequence of operations, the sequence may be altered without departing from the scope of the present disclosure. For example, some of the operations depicted may be performed in parallel or in a different sequence that does not materially affect the function of the process 1300. In other examples, different components of an example device or system that implements the process 1300 may perform functions at substantially the same time or in a specific sequence. One or more operations of process 1300 may be performed, as a non-limiting example, by liquid level sensing system 100 and sensing system 124.

According to one or more examples, process 1300 may include obtaining a further capacitance value generated at least partially responsive to a further capacitive level measurement performed using the level sensing electrode of a capacitive level sensor, the further capacitance value at least partially dependent on a level of liquid within the holding region of the holding structure at operation 1302.

According to one or more examples, process 1300 may include obtaining a first further reference value generated at least partially responsive to a first further capacitive distance measurement performed using the first distance sensing electrode of a capacitive distance sensor, the first further reference value at least partially dependent on a distance between the first distance sensing electrode and the first conductive structure on the wall of the holding structure at operation 1304.

According to one or more examples, process 1300 may include obtaining a second further reference value generated at least partially responsive to a second further capacitive distance measurement performed using the second distance sensing electrode of the second capacitive distance sensor, the second reference value at least partially dependent on a distance between the first distance sensing electrode and the second conductive structure on the wall of the holding structure at operation 1306.

According to one or more examples, process 1300 may include determining a first difference value based on a difference between the first reference value and the second reference value at operation 1308.

According to one or more examples, process 1300 may include determining a second difference value based on a difference between the first further reference value and the second further reference value at operation 1310.

According to one or more examples, process 1300 may include determining a first scaling factor and a second scaling factor at least partially based on the first difference value and the second difference value at operation 1312.

FIG. 14 continues process 1300.

According to one or more examples, process 1300 may include changing the first further reference value based on the first scaling factor at operation 1414.

According to one or more examples, process 1300 may include changing the second further reference value based on the second scaling factor at operation 1416.

According to one or more examples, process 1300 may include changing the further capacitance value at least partially based on the changed first further reference value and the changed second further reference value; and at operation 1418.

According to one or more examples, process 1300 may include determining a further value representative of the level of liquid within the holding region of the holding structure at least partially based on the changed further capacitance value at operation 1420. The system comprises a process 1300.

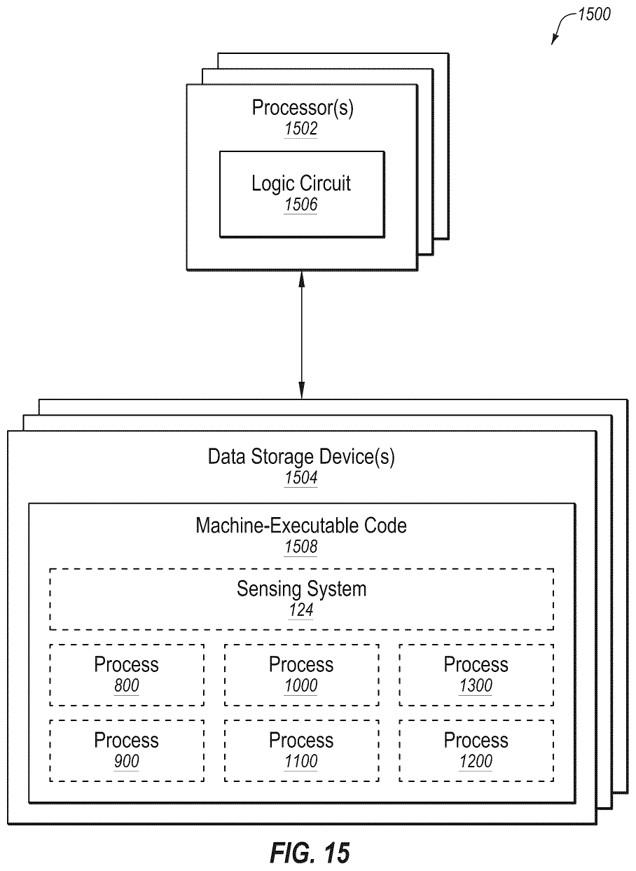

It will be appreciated by those of ordinary skill in the art that functional elements of examples disclosed herein (e.g., functions, operations, acts, processes, or methods) may be implemented in any suitable hardware, software, firmware, or combinations thereof. FIG. 15 illustrates non-limiting examples of implementations of functional elements disclosed herein. In some examples, some or all portions of the functional elements disclosed herein may be performed by hardware capable of carrying out the functional elements.

FIG. 15 is a block diagram of a circuitry 1500 that, in some examples, may be used to implement various functions, operations, acts, processes, or methods disclosed herein. The circuitry 1500 includes one or more processors 1502 (sometimes referred to herein as “processors 1502”) operably coupled to one or more data storage devices 1504 (sometimes referred to herein as “storage 1504”). The storage 1504 includes machine-executable instructions 1508 stored thereon, and the processors 1502 include logic circuit 1506. The machine-executable instructions 1508 information describe functional elements that may be implemented by (e.g., performed by) the logic circuit 1506. The logic circuit 1506 is adapted to implement (e.g., perform) the functional elements described by the machine-executable instructions 1508. The circuitry 1500, when executing the functional elements described by the machine-executable instructions 1508, should be considered as special purpose hardware for carrying out functional elements disclosed herein. In some examples, the processors 1502 may perform the functional elements described by the machine-executable instructions 1508 sequentially, concurrently (e.g., on one or more different hardware platforms), or in one or more parallel process streams.

When implemented by logic circuit 1506 of the processors 1502, the machine-executable instructions 1508 adapt the processors 1502 to perform operations of examples disclosed herein, including those discussed with respect to liquid level sensing system 100, environment 200, environment 400, or environment 600; or sensing system 124; or first capacitive distance sensor 114, second capacitive distance sensor 116, or capacitive liquid level sensor 118. By way of non-limiting example, the machine-executable instructions 1508 may adapt the processors 1502 to perform some or a totality of operations for adjusting capacitive liquid level measurement values including one or more operations of: process 800, process 900, process 1000, process 1100, process 1200, or process 1300.

Also by way of non-limiting example, the machine-executable instructions 1508 may adapt the processors 1502 to perform some or a totality of features, functions, or operations disclosed herein for one or more of: sensing system 124. More specifically, features, functions, or operations disclosed herein for one or more of: first capacitive distance sensor 114, second capacitive distance sensor 116, capacitive liquid level sensor 118.

The processors 1502 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable instructions 1508 (e.g., software code, firmware code, hardware descriptions) related to examples of the present disclosure. It is noted that a general-purpose processor (may also be referred to herein as a host processor or simply a host) may be a microprocessor, but in the alternative, the processors 1502 may include any conventional processor, controller, microcontroller, or state machine. The processors 1502 may also be implemented as a combination of computing devices, such as a combination of a DSP and a microprocessor, a plurality of microprocessors, one or more microprocessors in conjunction with a DSP core, or any other such configuration.

In some examples, the storage 1504 includes volatile data storage (e.g., random-access memory (RAM)), non-volatile data storage (e.g., Flash memory, a hard disc drive, a solid state drive, erasable programmable read-only memory (EPROM), without limitation). In some examples, the processors 1502 and the storage 1504 may be implemented into a single device (e.g., a semiconductor device product, a system on chip (SOC), without limitation). In some examples, the processors 1502 and the storage 1504 may be implemented into separate devices.

In some examples, the machine-executable instructions 1508 may include computer-readable instructions (e.g., software code, firmware code). By way of non-limiting example, the computer-readable instructions may be stored by the storage 1504, accessed directly by the processors 1502, and executed by the processors 1502 using at least the logic circuit 1506. Also by way of non-limiting example, the computer-readable instructions may be stored on the storage 1504, transferred to a memory device (not shown) for execution, and executed by the processors 1502 using at least the logic circuit 1506. Accordingly, in some examples, the logic circuit 1506 includes electrically configurable logic circuit 1506.

In some examples, the machine-executable instructions 1508 may describe hardware (e.g., circuitry) to be implemented in the logic circuit 1506 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG®, SYSTEMVERILOG™ or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1506 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, the sensing system 124 may include an HDL, an RTL, a GL description, a mask level description, other hardware description, or any combination thereof.

In examples where the machine-executable instructions 1508 include a hardware description (at any level of abstraction), a system (not shown, but including the storage 1504) implements the hardware description described by the machine-executable instructions 1508. By way of non-limiting example, the processors 1502 may include a programmable logic device (e.g., an FPGA or a PLC), and the logic circuit 1506 may be electrically controlled to implement circuitry corresponding to the hardware description into the logic circuit 1506. Also by way of non-limiting example, the logic circuit 1506 may include hard-wired logic manufactured by a manufacturing system (not shown, but including the storage 1504) according to the hardware description of the machine-executable instructions 1508.

Regardless of whether the machine-executable instructions 1508 includes computer-readable instructions or a hardware description, the logic circuit 1506 is adapted to perform the functional elements described by the machine-executable instructions 1508 when implementing the functional elements of the machine-executable instructions 1508. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, without limitation) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means “some or a totality.” As used herein, the term “each and every” means a “totality.”

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, without limitation” or “one or more of A, B, and C, without limitation” is used, in general such a construction is intended to include A alone, B alone, C alone, A and B together, A and C together, B and C together, or A, B, and C together, without limitation.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additional non-limiting examples include:

Example 1: A method comprising: obtaining a capacitance value generated at least partially responsive to a capacitive level measurement performed using a level sensing electrode of a capacitive level sensor, the capacitance value at least partially dependent on a level of liquid within a holding region of a holding structure; obtaining a first reference value generated at least partially responsive to a first capacitive distance measurement performed using a first distance sensing electrode of a capacitive distance sensor, the first reference value at least partially dependent on a distance between the first distance sensing electrode and a first conductive structure on a wall of the holding structure; obtaining a second reference value generated at least partially responsive to a second capacitive distance measurement performed using a second distance sensing electrode of a second capacitive distance sensor, the second reference value at least partially dependent on a distance between the second distance sensing electrode and a second conductive structure on the wall of the holding structure; changing the capacitance value at least partially based on the first reference value and the second reference value; and determining a value representative of the level of liquid within the holding region of the holding structure at least partially based on the changed capacitance value.

Example 2: The method according to Example 1, wherein changing the capacitance value at least partially based on the first reference value and the second reference value comprises: determining a difference between the first reference value and the second reference value; and changing the capacitance value at least partially based on the difference between the first reference value and the second reference value.

Example 3: The method according to Examples 1 and 2, comprising: providing in proximity to the wall of the holding structure: the level sensing electrode, the first distance sensing electrode, and the second distance sensing electrode.

Example 4: The method according to Examples 1 to 3, wherein, providing in proximity to the wall of the holding structure: the level sensing electrode, the first distance sensing electrode, and the second distance sensing electrode, comprises: providing the level sensing electrode opposite the wall of the holding structure; providing the first distance sensing electrode adjacent to a first end of the level sensing electrode, the first distance sensing electrode opposite the first conductive structure on the wall of the holding structure, the first conductive structure electrically connected to ground voltage potential; and providing the second distance sensing electrode adjacent to a second end of the level sensing electrode, the second distance sensing electrode opposite the second conductive structure on the wall of the holding structure, the second conductive structure electrically connected to ground voltage potential.

Example 5: The method according to Examples 1 to 4, wherein, providing in proximity to the wall of the holding structure: the level sensing electrode, the first distance sensing electrode, and the second distance sensing electrode, comprises: providing the level sensing electrode opposite the wall of the holding structure; providing the first distance sensing electrode adjacent to a first end of the level sensing electrode, the first distance sensing electrode opposite the first conductive structure on the wall of the holding structure, the first conductive structure electrically floating with respect to the first capacitive distance sensor; and providing the second distance sensing electrode adjacent to a second end of the level sensing electrode, the second distance sensing electrode opposite the second conductive structure on the wall of the holding structure, the second conductive structure electrically floating with respect to the second capacitive distance sensor.

Example 6: The method according to Examples 1 to 5, comprising: obtaining a further capacitance value generated at least partially responsive to a further capacitive level measurement performed using the level sensing electrode of a capacitive level sensor, the further capacitance value at least partially dependent on a level of liquid within the holding region of the holding structure; obtaining a first further reference value generated at least partially responsive to a first further capacitive distance measurement performed using the first distance sensing electrode of a capacitive distance sensor, the first further reference value at least partially dependent on a distance between the first distance sensing electrode and the first conductive structure on the wall of the holding structure; obtaining a second further reference value generated at least partially responsive to a second further capacitive distance measurement performed using the second distance sensing electrode of the second capacitive distance sensor, the second reference value at least partially dependent on a distance between the first distance sensing electrode and the second conductive structure on the wall of the holding structure; determining a first difference value based on a difference between the first reference value and the second reference value; determining a second difference value based on a difference between the first further reference value and the second further reference value; determining a first scaling factor and a second scaling factor at least partially based on the first difference value and the second difference value; changing the first further reference value based on the first scaling factor; changing the second further reference value based on the second scaling factor; changing the further capacitance value at least partially based on the changed first further reference value and the changed second further reference value; and determining a further value representative of the level of liquid within the holding region of the holding structure at least partially based on the changed further capacitance value.

Example 7: An apparatus comprising: a capacitive level sensor, the capacitive level sensor including a level sensing electrode, the capacitive level sensor to generate capacitance values at least partially responsive to capacitive level measurements via the level sensing electrode of the capacitive level sensor, the capacitance values at least partially dependent on level of liquid within a holding region of a holding structure; a first capacitive distance sensor including a distance sensing electrode, the first capacitive distance sensor to generate reference values at least partially responsive to capacitive distance measurements via the distance sensing electrode of the first capacitive distance sensor, the reference values generated by the firs capacitance distance sensor at least partially dependent on distance between the first distance sensing electrode and a first conductive structure on a wall of the holding structure; a second capacitive distance sensor including a distance sensing electrode, the second capacitive distance sensor to generate reference values at least partially responsive to capacitive distance measurements via the distance sensing electrode of the second capacitive distance sensor, the reference values generated by the second capacitance distance sensor at least partially dependent on distance between the second distance sensing electrode and a second conductive structure on the wall of the holding structure; and a logic circuit to: obtain a capacitance value from the capacitive level sensor; obtain a first reference value from the first capacitive sensor; obtain a second reference value from the second capacitive sensor; change the capacitance value at least partially based on the first reference value and the second reference value; and determine a value representative of the level of liquid within the holding region of the holding structure at least partially based on the changed capacitance value.

Example 8: The apparatus according to Example 7, wherein: the first distance sensing electrode is arranged adjacent to a first end of the level sensing electrode; and the second distance sensing electrode is arranged adjacent to a second end of the level sensing electrode.

Example 9: The apparatus according to Examples 7 and 8, wherein the first distance sensing electrode and the second distance sensing electrode are located outside an effective region of the capacitive level sensor.

Example 10: The apparatus according to Examples 7 to 9, wherein the logic circuit to: determine a difference between the first reference value and the second reference value; and change the capacitance value at least partially based on the difference between the first reference value and the second reference value.

Example 11: The apparatus according to Examples 7 to 10, wherein the logic circuit to: obtain a further capacitance value from the capacitive level sensor; obtain a first further reference value from the first distance sensor; obtain a second further reference value from the second capacitive distance sensor; determine a first difference value based on a difference between the first reference value and the second reference value; determine a second difference value based on a difference between the first further reference value and the second further reference value; determine a first scaling factor and a second scaling factor at least partially based on the first difference value and the second difference value; change the first further reference value based on the first scaling factor; change the second further reference value based on the second scaling factor; change the further capacitance value at least partially based on the changed first further reference value and the changed second further reference value; and determine a further value representative of the level of liquid within the holding region of the holding structure at least partially based on the changed further capacitance value.

Example 12: The apparatus according to Examples 7 to 11, comprising a support structure having on a surface thereof: the level sensing electrode of the capacitive level sensor; the distance sensing electrode of the first capacitive distance sensor; and the distance sensing electrode of the second capacitive distance sensor.

Example 13: A system comprising: a holding structure; a support structure, the support structure having a surface to position in proximity to a wall of the holding structure; a capacitive level sensor, the capacitive level sensor including a level sensing electrode on the surface of the support structure; a first capacitive distance sensor, the first capacitive distance sensor including a first distance sensing electrode and a first conductive structure, the first distance sensing electrode on the surface of the support structure adjacent to a first end of the level sensing electrode, the first distance sensing electrode opposite a first conductive structure on a wall of the holding structure; and a second capacitive distance sensor, the second capacitive distance sensor including a second distance sensing electrode and a second conductive structure, the second distance sensing electrode on the surface of the support structure adjacent to a second end of the level sensing electrode, the second distance sensing electrode opposite a second conductive structure on the wall of the holding structure.

Example 14: The system according to Example 13, wherein the first conductive structure and the second conductive structure are electrically connected to a ground voltage potential.

Example 15: The system according to Examples 13 and 14, wherein the first conductive structure and the second conductive structure are electrically floating with respect to the first capacitive distance sensor.

Example 16: The system according to Examples 13 to 15, comprising a logic circuit to: obtain a capacitance value from the capacitive level sensor; obtain a first reference value from the first capacitive sensor; obtain a second reference value from the second capacitive sensor; change the capacitance value at least partially based on the first reference value and the second reference value; and determine a value representative of the level of liquid within the holding region of the holding structure at least partially based on the changed capacitance value.

Example 17: The system according to Examples 13 to 16, wherein the logic circuit to: obtain a further capacitance value from the capacitive level sensor; obtain a first further reference value from the first distance sensor; obtain a second further reference value from the second capacitive distance sensor; determine a first difference value based on a difference between the first reference value and the second reference value; determine a second difference value based on a difference between the first further reference value and the second further reference value; determine a first scaling factor and a second scaling factor at least partially based on the first difference value and the second difference value; change the first further reference value based on the first scaling factor; change the second further reference value based on the second scaling factor; change the further capacitance value at least partially based on the changed first further reference value and the changed second further reference value; and determine a further value representative of the level of liquid within the holding region of the holding structure at least partially based on the changed further capacitance value.

Example 18: The system according to Examples 13 to 17, wherein the logic circuit to: obtain a further capacitance value from the capacitive level sensor; obtain a first further reference value from the first distance sensor; obtain a second further reference value from the second capacitive distance sensor; determine a first difference value based on a difference between the first reference value and the second reference value; determine a second difference value based on a difference between the first further reference value and the second further reference value; generate a signal to indicate a change in position of the holding structure at least partially responsive to the first difference value and the second difference value being different.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method comprising:
obtaining a capacitance value generated at least partially responsive to a capacitive level measurement performed using a level sensing electrode of a capacitive level sensor, the capacitance value at least partially dependent on a level of liquid within a holding region of a holding structure;
obtaining a first reference value generated at least partially responsive to a first capacitive distance measurement performed using a first distance sensing electrode of a capacitive distance sensor, the first reference value at least partially dependent on a distance between the first distance sensing electrode and a first conductive structure on a wall of the holding structure;
obtaining a second reference value generated at least partially responsive to a second capacitive distance measurement performed using a second distance sensing electrode of a second capacitive distance sensor, the second reference value at least partially dependent on a distance between the second distance sensing electrode and a second conductive structure on the wall of the holding structure;
changing the capacitance value at least partially based on the first reference value and the second reference value; and
determining a value representative of the level of liquid within the holding region of the holding structure at least partially based on the changed capacitance value.

2. The method of claim 1, wherein changing the capacitance value at least partially based on the first reference value and the second reference value comprises:
determining a difference between the first reference value and the second reference value; and
changing the capacitance value at least partially based on the difference between the first reference value and the second reference value.

3. The method of claim 1, comprising:
providing in proximity to the wall of the holding structure: the level sensing electrode, the first distance sensing electrode, and the second distance sensing electrode.

4. The method of claim 3, wherein, providing in proximity to the wall of the holding structure: the level sensing electrode, the first distance sensing electrode, and the second distance sensing electrode, comprises:
providing the level sensing electrode opposite the wall of the holding structure;
providing the first distance sensing electrode adjacent to a first end of the level sensing electrode, the first distance sensing electrode opposite the first conductive structure on the wall of the holding structure, the first conductive structure electrically connected to ground voltage potential; and
providing the second distance sensing electrode adjacent to a second end of the level sensing electrode, the second distance sensing electrode opposite the second conductive structure on the wall of the holding structure, the second conductive structure electrically connected to ground voltage potential.

5. The method of claim 3, wherein, providing in proximity to the wall of the holding structure: the level sensing electrode, the first distance sensing electrode, and the second distance sensing electrode, comprises:
providing the level sensing electrode opposite the wall of the holding structure;
providing the first distance sensing electrode adjacent to a first end of the level sensing electrode, the first distance sensing electrode opposite the first conductive structure on the wall of the holding structure, the first conductive structure electrically floating with respect to the first capacitive distance sensor; and
providing the second distance sensing electrode adjacent to a second end of the level sensing electrode, the second distance sensing electrode opposite the second conductive structure on the wall of the holding structure, the second conductive structure electrically floating with respect to the second capacitive distance sensor.

6. The method of claim 1, comprising:
obtaining a further capacitance value generated at least partially responsive to a further capacitive level measurement performed using the level sensing electrode of a capacitive level sensor, the further capacitance value at least partially dependent on a level of liquid within the holding region of the holding structure;
obtaining a first further reference value generated at least partially responsive to a first further capacitive distance measurement performed using the first distance sensing electrode of a capacitive distance sensor, the first further reference value at least partially dependent on a distance between the first distance sensing electrode and the first conductive structure on the wall of the holding structure;
obtaining a second further reference value generated at least partially responsive to a second further capacitive distance measurement performed using the second distance sensing electrode of the second capacitive distance sensor, the second reference value at least partially dependent on a distance between the first distance sensing electrode and the second conductive structure on the wall of the holding structure;
determining a first difference value based on a difference between the first reference value and the second reference value;
determining a second difference value based on a difference between the first further reference value and the second further reference value;
determining a first scaling factor and a second scaling factor at least partially based on the first difference value and the second difference value;
changing the first further reference value based on the first scaling factor;
changing the second further reference value based on the second scaling factor;
changing the further capacitance value at least partially based on the changed first further reference value and the changed second further reference value; and
determining a further value representative of the level of liquid within the holding region of the holding structure at least partially based on the changed further capacitance value.

7. An apparatus comprising:
a capacitive level sensor, the capacitive level sensor including a level sensing electrode, the capacitive level sensor to generate capacitance values at least partially responsive to capacitive level measurements via the level sensing electrode of the capacitive level sensor, the capacitance values at least partially dependent on level of liquid within a holding region of a holding structure;
a first capacitive distance sensor including a distance sensing electrode, the first capacitive distance sensor to generate reference values at least partially responsive to capacitive distance measurements via the distance sensing electrode of the first capacitive distance sensor, the reference values generated by the firs capacitance distance sensor at least partially dependent on distance between the first distance sensing electrode and a first conductive structure on a wall of the holding structure;
a second capacitive distance sensor including a distance sensing electrode, the second capacitive distance sensor to generate reference values at least partially responsive to capacitive distance measurements via the distance sensing electrode of the second capacitive distance sensor, the reference values generated by the second capacitance distance sensor at least partially dependent on distance between the second distance sensing electrode and a second conductive structure on the wall of the holding structure; and
a logic circuit to:
obtain a capacitance value from the capacitive level sensor;
obtain a first reference value from the first capacitive distance sensor;
obtain a second reference value from the second capacitive distance sensor;
change the capacitance value at least partially based on the first reference value and the second reference value; and
determine a value representative of the level of liquid within the holding region of the holding structure at least partially based on the changed capacitance value.

8. The apparatus of claim 7, wherein:
the first distance sensing electrode is arranged adjacent to a first end of the level sensing electrode; and
the second distance sensing electrode is arranged adjacent to a second end of the level sensing electrode.

9. The apparatus of claim 8, wherein the first distance sensing electrode and the second distance sensing electrode are located outside an effective region of the capacitive level sensor.

10. The apparatus of claim 7, wherein the logic circuit to:
determine a difference between the first reference value and the second reference value; and
change the capacitance value at least partially based on the difference between the first reference value and the second reference value.

11. The apparatus of claim 7, wherein the logic circuit to:
obtain a further capacitance value from the capacitive level sensor;
obtain a first further reference value from the first distance sensor;
obtain a second further reference value from the second capacitive distance sensor;
determine a first difference value based on a difference between the first reference value and the second reference value;
determine a second difference value based on a difference between the first further reference value and the second further reference value;
determine a first scaling factor and a second scaling factor at least partially based on the first difference value and the second difference value;
change the first further reference value based on the first scaling factor;
change the second further reference value based on the second scaling factor;
change the further capacitance value at least partially based on the changed first further reference value and the changed second further reference value; and
determine a further value representative of the level of liquid within the holding region of the holding structure at least partially based on the changed further capacitance value.

12. The apparatus of claim 7, comprising a support structure having on a surface thereof:
the level sensing electrode of the capacitive level sensor;
the distance sensing electrode of the first capacitive distance sensor; and
the distance sensing electrode of the second capacitive distance sensor.

13. A system comprising:
a holding structure;
a support structure, the support structure having a surface to position in proximity to a wall of the holding structure;
a capacitive level sensor, the capacitive level sensor including a level sensing electrode on the surface of the support structure;
a first capacitive distance sensor, the first capacitive distance sensor including a first distance sensing electrode and a first conductive structure, the first distance sensing electrode on the surface of the support structure adjacent to a first end of the level sensing electrode, the first distance sensing electrode opposite a first conductive structure on a wall of the holding structure; and
a second capacitive distance sensor, the second capacitive distance sensor including a second distance sensing electrode and a second conductive structure, the second distance sensing electrode on the surface of the support structure adjacent to a second end of the level sensing electrode, the second distance sensing electrode opposite a second conductive structure on the wall of the holding structure.

14. The system of claim 13, wherein the first conductive structure and the second conductive structure are electrically connected to a ground voltage potential.

15. The system of claim 13, wherein the first conductive structure and the second conductive structure are electrically floating with respect to the first capacitive distance sensor.

16. The system of claim 13, comprising a logic circuit to:
obtain a capacitance value from the capacitive level sensor;
obtain a first reference value from the first capacitive sensor;
obtain a second reference value from the second capacitive sensor;
change the capacitance value at least partially based on the first reference value and the second reference value; and
determine a value representative of the level of liquid within a holding region of the holding structure at least partially based on the changed capacitance value.

17. The system of claim 16, wherein the logic circuit to:
obtain a further capacitance value from the capacitive level sensor;
obtain a first further reference value from the first distance sensor;
obtain a second further reference value from the second capacitive distance sensor;
determine a first difference value based on a difference between the first reference value and the second reference value;
determine a second difference value based on a difference between the first further reference value and the second further reference value;
determine a first scaling factor and a second scaling factor at least partially based on the first difference value and the second difference value;
change the first further reference value based on the first scaling factor;
change the second further reference value based on the second scaling factor;
change the further capacitance value at least partially based on the changed first further reference value and the changed second further reference value; and
determine a further value representative of the level of liquid within the holding region of the holding structure at least partially based on the changed further capacitance value.

18. The system of claim 16, wherein the logic circuit to:
obtain a further capacitance value from the capacitive level sensor;
obtain a first further reference value from the first distance sensor;
obtain a second further reference value from the second capacitive distance sensor;
determine a first difference value based on a difference between the first reference value and the second reference value;
determine a second difference value based on a difference between the first further reference value and the second further reference value; and
generate a signal to indicate a change in position of the holding structure at least partially responsive to the first difference value and the second difference value being different.
